(19) United States
(12) Patent Application Publication
(10) Pub. No.: US 2010/0099585 A1
(43) Pub. Date: Apr. 22, 2010

(54) AQUEOUS BASE WELLBORE FLUIDS FOR HIGH TEMPERATURE-HIGH PRESSURE APPLICATIONS AND METHODS OF USE

(76) Inventor: Ahmadi Tehrani, Kincardineshire (GB)

Correspondence Address: LEGAL DEPT., IP GROUP;M-I L.L.C., 5950 NORTH COURSE DRIVE, HOUSTON, TX, 77072, US

(21) Appl. No.: 12/531,453

(22) PCT Filed: Mar. 20, 2008
(86) PCT No.: PCT/US08/57667

§ 371 Date: Sep. 15, 2009

Related U.S. Application Data
(60) Provisional application No. 60/896,848, filed on Mar. 23, 2007.

(51) Int. Cl. C09K 8/12; C09K 8/60; C09K 8/24

(52) U.S. Cl. 507/119; 507/219; 507/224; 507/229; 507/117; 507/123

(57) ABSTRACT

Embodiments disclosed herein related to an aqueous based well bore fluid that includes at least one ionized polymer, at least one non-ionic polymer, a non-magnetic weighting agent, and an aqueous base fluid.

### FIELD OF INVENTION

The invention relates generally to wellbore fluids, and more specifically to aqueous based drilling fluid for high-temperature-high-pressure applications.

### BACKGROUND OF INVENTION

When drilling or completing wells in earth formations, various fluids are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

Drilling fluids are generally characterized as thixotropic fluid systems. That is, they exhibit low viscosity when sheared, such as when in circulation (as occurs during pumping or contact with the moving drilling bit). However, when the shearing action is halted, the fluid should be capable of suspending the solids it contains to prevent gravity separation. In addition, when the drilling fluid is under shear conditions and free-flowing near-liquid, it must retain sufficiently high enough viscosity to carry all the unwanted particulate matter from the bottom of the wellbore to the surface.

To obtain the fluid characteristics required to meet these challenges, the fluid must be easy to pump, so it requires the minimum amount of pressure to force it through restrictions in the circulating fluid system, such as bit nozzles or down-hole tools. In other words, the fluid must have the lowest possible viscosity under high shear conditions. Conversely, in zones of the well where the area for fluid flow is large and the velocity of the fluid is slow or where there are low shear conditions, the viscosity of the fluid needs to be as high as possible in order to suspend and transport the drilled cuttings. However, it should also be noted that the viscosity of the fluid should not continue to increase under static conditions to unacceptable levels. Otherwise, when the fluid needs to be circulated again, excessive pressures can build to the point that the formation is fractured.

Currently available fluid systems that offer a high degree of shear-thinning are generally based on biopolymers (e.g. xanthan and scleroglucan gum) or certain organic mixtures. While the most effective polymers for rheology control are those with high molecular weight (millions of Dalton), and a high molecular weight polymer in aqueous solution generates rheology capable of suspending dispersed solids, high molecular weight polymers provide high plastic viscosity. Further, at temperatures above 130° C. (265° F.), biopolymers and organic mixtures experience stability problems. These problems, which may be intensified by the high solids fraction of heavier drilling fluids, can lead to large pressure losses in narrow well sections.

Accordingly, there exists a need to provide an aqueous-based wellbore fluid capable of withstanding the stress of HTHP environments, while maintaining desirable rheological properties.

### SUMMARY OF INVENTION

In one aspect of the invention, embodiments disclosed herein related to an aqueous based wellbore fluid includes at least one ionized polymer, at least one non-ionic polymer, a non-magnetic weighting agent, and an aqueous base fluid.

In another aspect, embodiments disclosed herein relate to a method for drilling a wellbore, which includes circulating an aqueous based wellbore fluid while drilling, wherein the aqueous base wellbore fluid includes at least one ionized polymer, at least one non-ionic polymer, a non-magnetic weighting agent, and an aqueous base fluid.

Other aspects and advantages of the claimed subject matter will be apparent from the following description and the appended claims.

### BRIEF DESCRIPTION OF THE DRAWINGS

FIG. 1 shows a graphical representation of the effect on plastic viscosity as the concentration of anionic polymer increases.

FIG. 2 shows a graphical representation of the effect on plastic viscosity as the concentration of non-ionic polymer increases.

FIG. 3 shows a graphical representation of the effect on yield point as the concentration of anionic polymer increases.

FIG. 4 shows a graphical representation of the effect on yield point as the concentration of non-ionic polymer increases.

FIG. 5 shows a graphical representation of the effect on API fluid loss as the concentration of anionic polymer increases.

FIG. 6 shows a graphical representation of the effect on API fluid loss as the concentration of non-ionic polymer increases.

FIG. 7 shows a graphical representation of the filtration rate as a function of time.

FIG. 8 shows a graphical comparison of the lubricity of the fluid of the present invention versus the lubricity of a conventional oil-based fluid.

### DETAILED DESCRIPTION

In one aspect, embodiments disclosed herein relate to aqueous based wellbore fluids for use in HTHP wellbore environments, wherein the wellbore fluid includes at least one ionized polymer, at least one non-ionic polymer, a non-magnetic weighting agent, and an aqueous base fluid. As used herein, “high temperature” environments have temperatures of at least 130° C. (265° F.). In another aspect, embodiments disclosed herein relate to methods for drilling a wellbore, including circulating the aqueous based wellbore fluid within the wellbore while drilling, wherein the aqueous based wellbore fluid includes at least one ionized polymer and at least one non-ionic polymer, a non-magnetic weight material and an aqueous base fluid.

The inventors have surprisingly discovered that combining ionized and non-ionic polymers with a non-magnetic weight material in an aqueous base fluid yield a synergistic effect, whereby the wellbore fluid maintains its rheological and fluid loss performance in HTHP environments. One of ordinary skill in the art may appreciate that the right combination of polymers and weight material can produce a fluid that is tolerant to various additives used in water-based systems and offers excellent rheology and fluid loss control up to 180° C. (356° F.). One of ordinary skill in the art may also appreciate that the fluid also allows control of rheology to achieve specific targets of yield point and plastic viscosity by adjusting additive concentration.

In one embodiment of the invention, the polymers and the weight material are selected such that they both contribute to the generation and control of a highly shear-thinning, thermally stable rheology. This is achieved through a synergistic interaction between the polymers and the weight material. Preferred polymers have the following properties: moderate molecular weight, low charge density, and stability at high temperatures. Polymers that satisfy the criteria produce relatively low viscosity if used on their own, which may not be adequate for suspending the weight material and for cuttings transport. However, when combined with a non-magnetic weight material with a specific surface charge, they produce highly shear-thinning aggregates with good suspending capacity.

One of skill in the art may appreciate that the low charge density of the polymers disclosed herein increases the backbone rigidity of the polymer, thereby impacting the plastic viscosity. Further, one of ordinary skill in the art may appreciate that low charge density results in polyelectrolytes that are more sensitive to salts. Additionally, one of ordinary skill in the art may appreciate that the impact of drill cuttings and cement contamination in the wellbore fluid is reduced due to the low charge density of the polymers disclosed herein.

Excessive plastic viscosity may be avoided through the use of a moderate molecular weight polymer. The moderate molecular weight polymers adsorb on dispersed solids and interact with dissolved polymers to produce highly shear-thinning rheology. Polymers suitable for use in this approach include mixtures of ionized and non-ionic polymers able to interact and adsorb on the solid particles, and create a weakly aggregating network between the polymer-covered solids and the polymer in solution. The interaction produces a system with high low-shear-rate rheology and with highly shear-thinning characteristics.

Ionized Polymers

As used herein, “ionized polymers” refer to any polymer possessing an electrically charged site on the polymer molecule. The ionized polymer may carry a cationic (positive charge), an anionic (negative) charge, and combinations thereof in some embodiments, synthetic, ionized polymers are preferred. One of skill in the art will appreciate that numerous polymers could be used, provided the polymer is synthetic and is ionized. In some embodiments, preferred ionized polymers include modified acrylic polymers. The chemical modification of the acrylic polymer has a strong effect on its interaction with the non-ionic polymer and with the solid particle surface of the non-magnetized weighting agents, both described herein. Both anionic and cationic modified acrylic polymers may be used. In other embodiments, preferred ionized polymers include vinyl sulfonated copolymers.

Non-Ionic Polymers

As used herein, “nonionic polymers” refer to any polymer possessing no charged sites on the polymer molecule. In some embodiments, moderate weight nonionic polymers are preferred. As used herein, “moderate weight nonionic polymers” refer to nonionic polymers with a molecular weight in the range of about 200,000 to about 1,000,000. The molecular weight of the nonionic polymer affects the overall performance of the wellbore fluid. One of ordinarly skill in the art may appreciate that ss the molecular weight of nonionic polymer increases, the wellbore fluid has produced better results. Thus, in some embodiments, synthetic polymers having moderate molecular weights in the range of 200,000 to about 1,000,000 are preferred.

In other embodiments, polyvinylpyrrolidone (PVP) is preferred. PVP is a water-soluble polymer derived from N-vinyl pyrrolidone. When dissolved with fresh water and used on its own, one of ordinary skill in the art will appreciate that PVP has a weak viscosifying effect with Newtonian character, thereby producing the desired stability and rheological properties.

Table 1 presents the relationship between Fikentscher K-value and the approximate molecular weight of PVP. The Fikentscher K-value is derived from measurements of the relative viscosity of polymer solutions.

TABLE 1

| K-value Range | M_{η} | M_{w} |
|---|---|---|
| 13-19 | 10,000 | 12,000 |
| 26-34 | 40,000 | 55,000 |
| 50-62 | 220,000 | 400,000 |
| 80-100 | 630,000 | 1,280,000 |
| 115-125 | 1,450,000 | 2,800,000 |

Source: GAF(ISP) Technical Bulletin 2302-203 SM-1290, “PVP polyvinylpyrrolidone Polymers,” 1990.

In some embodiments, the PVP K-value is at least 50. In other embodiments, the PVP K-value is at least 90.

Weighting Agent

Weighting agents are generally added to a wellbore fluid to impart increased density. In some embodiments, a non-magnetic weight material having a surface charge is preferred. In other embodiments, the weighting agent is manganese tetroxide. However, one of skill in the art will appreciate that other weight materials, such as barite, may be used, provided the weight material is non-magnetic and has a surface charge.

In some embodiments, the particle size of the weighting agent is less than 10 microns. In other embodiments the particle size of the weighting agent is less than 5 microns.

Base Fluid

The aqueous fluid of the wellbore fluid may include at least one of fresh water, sea water, brine, mixtures of water and water soluble organic compounds, and mixtures thereof. For example, the aqueous fluid may be formulated with mixtures of desired salts in fresh water. Such salts may include, but are not limited to, alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formats, nitrates, oxides, phosphates, sulfates, silicates, and fluorides. Saltes that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Other additives that may be included in the wellbore fluids disclosed herein include, for example, wetting agents, viscosifiers, surfactants, shale hydration inhibitors, filtration reducers, pH buffers, fluid loss control agents and thinners.

### EXAMPLES

### Example 1

The effect of the present invention was examined in a water-based drilling fluid formulation similar to that provided in Table 2. The design specifications of the fluid are outlined in Table 3. Plastic viscosity (PV) and Yield Point (YP) are measured on an oilfield-type rotational viscometer, such as the 6-speed Farm 35 viscometer. PV is a measure of the high-shear-rate viscosity of the fluid and is calculated from the measurements at 600- and 300-rpm rotational speeds and is equal to PV=θ₆₀₀-θ₃₀₀ centipoise (mPa·s). YP is a measure of the yield stress of the fluid and is calculated from YP=2θ₃₀₀-θ₆₀₀ lb/100 ft². The unit lb/100 ft² is an oilfield unit, which is equivalent to 0.48 Pa. API fluid loss gives information about the filtration characteristics of the drilling fluid to the formation. It is the volume of filtrate collected in 30 minutes by allowing the drilling fluid to filter through an API filter paper (2.5-micron average pore size) at ambient temperature and under a differential pressure of 100 psi.

TABLE 2
Table 1 - Initial Formulation of the 15.Oppg
Fluid

| | Concentration |
|---|---|
| Product | pb/bbl) |
| Water | 251.9 |
| Manganese tetroxide | 350.0 |
| Ionic polymer | 0-5.6 |
| Non-ionic polymer | 0-6.2 |
| Shale inhibitor | 18.7 |
| Fluid loss additive | 2.0 |

TABLE 3

| | |
|---|---|
| Density | 15 ppg (1800 kg/m³) |
| Temperature Stability | Up to 356° F. (180° C.) |
| Plastic Viscosity (@122° F. (50° C.)) | <30 cP |
| Yield Point (@122° F. (50° C.)) | >12 lb/100 ft² |
| API Fluid Loss (@122° F. (50° C.)) | <3 mL |

The formulation contained manganese tetroxide as the weight material, the anionic and non-ionic polymers for rheology control, an alkylglycol to provide shale inhibition, and a cellulosic material for fluid loss control. Additionally, the fluid was required to be stable to contaminants such as water, drill solids and cement, and have good shale inhibition, lubricity.

The fluids were prepared using a high-shear mixer, shearing the fluids for a 60 minutes. After measuring the rheology of the fluid at 50° C. (122° F.), the fluid was transferred to a high-pressure aging cell and hot rolled in a rolling oven for 16 hours and 356° F. After hot-rolling the fluid was cooled and homogenized on a high-shear mixer, and its theology was measured once again. By comparing the rheology of the fluid before and after hot rolling, it was possible to assess the temperature stability of the fluid. For example, a significant drop, particularly at low shear rates, or a major increase at high shear rates, indicated poor stability to high temperatures. The fluid-loss characteristics of the fluid were measured after hot rolling. Stability to contaminants, shale inhibition characteristics and lubricity were evaluated and optimized at a later stage.

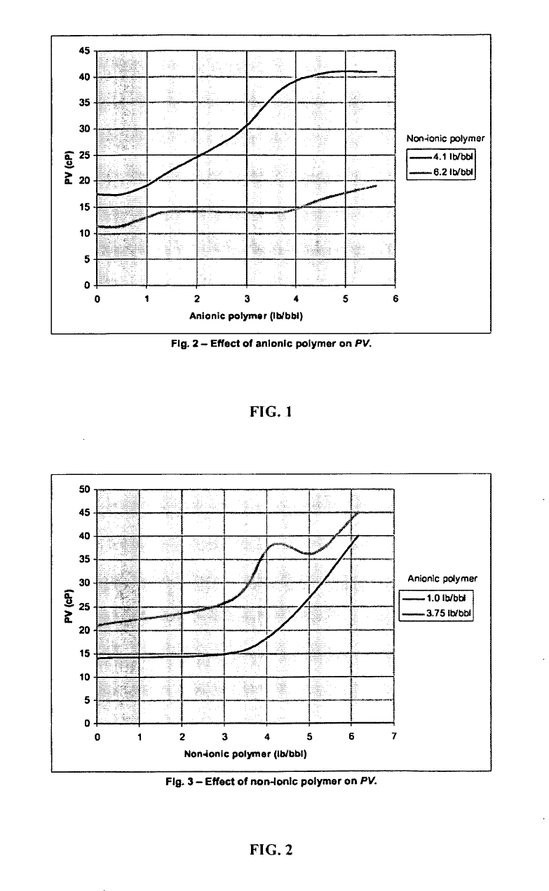

The sensitivity of fluid properties to the concentrations of the two polymers was evaluated in a series of tests where the concentrations of the two polymers were varied in the formulation of Table 2. FIGS. 1-6 illustrate the results.

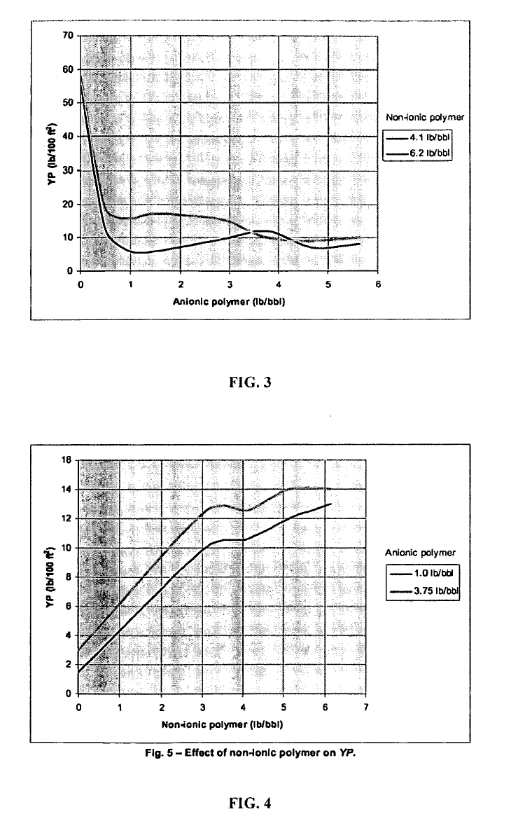

FIGS. 1 and 2 show that PV increases with increasing concentrations of both the anionic and non-ionic polymers. In comparison, FIGS. 3 and 4 illustrate that YP decreases with increasing concentration of the anionic polymer, but increases with increasing non-ionic polymer. Particularly noteworthy is the effect of the anionic polymer on lowering the yield point.

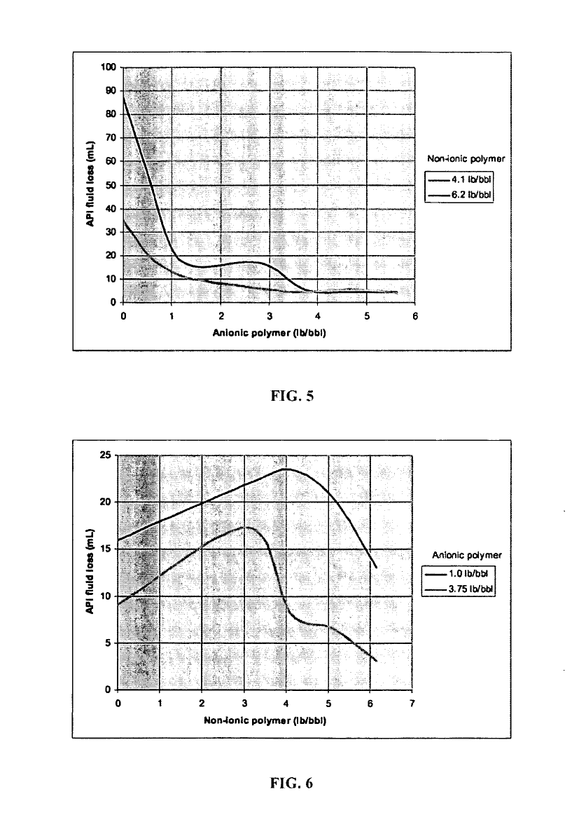

The effect of the two additives on fluid loss are shown in FIGS. 5 and 6. the anionic polymer is very effective in reducing fluid loss while the non-ionic polymer has a less prominent effect. Review of the results indicates that an ideal concentration of the two polymers is as follows: anionic polymer—3.75 lb/bbl; non-ionic polymer—4.10 lb/bbl. At these concentrations, the rheology and fluid loss properties of the fluid are detailed in Table 4.

TABLE 4
Properties of Fluid of Table I (hot roll temperature = 356° Ft

| | | Fann 35 readings at 120° F. | | | | | | | | | | |
|---|---|---|---|---|---|---|---|---|---|---|---|---|
| | | rpm | | | | | | Gels | | | | |
| Fluid # | | 600 | 300 | 200 | 100 | 6 | 3 | 10-s | 10-min | PV | YP | API |
| 12a | BHR* | 149 | 90 | 68 | 44 | 15 | 12 | 17 | 24 | 59 | 31 | — |
| | AHR* | 88 | 50 | 36 | 21 | 3 | 2 | 3 | 3 | 38 | 12 | 5.3 |

*BHR = Before Hot Rolling, AHR = After Hot Rolling.

It can be seen that PV and fluid-loss values are somewhat above the target specifications. It was found that reducing the concentration of the non-ionic polymer to lower PV was not a good option as it affected the stability of the fluid. Thus, PV was lowered by decreasing the concentration of the anionic polymer and by using a more effective fluid-loss-control additive.

### Example 2

A number of synthetic polymers were evaluated as high-temperature fluid-loss-control additives for the fluid system, including a lignosulfonate polymer, vinylamide/vinylsulfonate copolymers, an anionic acrylamide copolymer and sized carbonates. It was found that a combination of the lignosulfonate resin and sized carbonate (d50=25 im) was particularly beneficial for reducing fluid loss.

Although the new formulation gave a low fluid loss, it had an adverse effect on plastic viscosity. This required the use of an effective dispersant or rheology stabilizer. Organic stabilizers such as zirconium citrate and gallic acid were found to be capable of improving the stability of the fluid. Exemplary formulation and the resulting fluid properties are given in Tables 5 and 6. The formulation in Table 5 brought the rheology and fluid loss within specifications.

TABLE 5
Fluid Formulation

| | Concentration |
|---|---|
| Product | (lb/bbl) |
| Water | 251 |
| Manganese tetroxide | 320 |
| Anionic Polymer | 1.75 |
| Non-ionic Polymer | 4.1 |
| Shale Inhibitor | 18.7 |
| Synthetic Resin | 2.0 |
| Ziconium citrate | 3.33 |
| Gallic acid | 0.25 |
| Sized Carbonate | 30 |

TABLE 6
Properties of Fluids Containing Temperature Stabilisers

| | | Fann 35 readings at | | | | | | Gels | | | |
|---|---|---|---|---|---|---|---|---|---|---|---|
| | | 50° C. | | | | | 10- | 10- | | | API |
| | 600 | 300 | 200 | 100 | 6 | 3 | s | min | PV | YP | (mL) |
| BHR | 57 | 31 | 23 | 14 | 4 | 3 | 4 | 5 | 26 | 5 | — |
| AHR | 65 | 39 | 29 | 19 | 6 | 5 | 7 | 12 | 26 | 13 | 2.6 |

Alternative Weight Materials

The fluid of Table 5 was reformulated with three alternative weight materials: API barite, fine-grind barite (d₅₀=2 μm) and a 50/50 mixture of fine-grind barite and manganese tetroxide, as shown in Table 7. The properties of the fluids, before and after hot rolling at 180° C., are shown in Table 8. The new fluids appeared to undergo a degree of flocculation and produced higher plastic viscosity upon heat aging. The fluids also showed evidence of barite settling, which was responsible for the very low fluid-loss values. Clearly, replacement of manganese tetroxide with barite disrupted the stabilising interaction that existed between manganese tetroxide and the two polymers, and resulted in undesirable rheological effects. Improving the properties of these fluids would require a different approach to generating fluid rheology or developing new thermally stable polymeric materials.

TABLE 7
Fluid Formulations with Different Weight Materials

| | |
|---|---|
| | Concentration |
| Product | (lb/bbl) |

| | | | | |
|---|---|---|---|---|
| Water | 251 | 240 | 240 | 245.5 |
| Manganese tetroxide | 320 | — | — | 160 |
| API barite | — | 332 | — | — |
| Fine-grind barite | — | — | 332 | 166 |
| Anionic Polymer | 1.75 | 2 | 2 | 2 |
| Non-ionic Polymer | 4.1 | 18.7 | 18.7 | 18.7 |
| Shale Inhibitor | 18.7 | 4.1 | 4.1 | 4.1 |
| Synthetic Resin | 2.0 | 3 | 3 | 3 |
| Ziconium citrate | 3.33 | 3.33 | 3.33 | 3.33 |
| Gallic acid | 0.25 | 0.25 | 0.25 | 0.25 |
| Sized Carbonate | 30 | 30 | 30 | 30 |

TABLE 8
Effect of Weight Material on Fluid Properties

| | | Fann 35 readings at | | | | | | | | | | |
|---|---|---|---|---|---|---|---|---|---|---|---|---|
| Weight | | 50° C. | | | | | | | Gels | | | API |
| Material | | 600 | 300 | 200 | 100 | 6 | 3 | 10-s | 10-m | PV | YP | (mL) |
| Manganese | BHR | 57 | 31 | 23 | 14 | 4 | 3 | 4 | 5 | 26 | 5 | — |
| tetroxide (MT) | AHR | 65 | 39 | 29 | 19 | 6 | 5 | 7 | 12 | 26 | 13 | 2.6 |
| API barite | BHR | 86 | 45 | 31 | 17 | 3 | 2 | 3 | 3 | 41 | 4 | — |
| | AHR | 120 | 64 | 44 | 24 | 3 | 3 | 3 | 5 | 56 | 8 | 0.6 |
| Fine-grind | BHR | 92 | 50 | 35 | 20 | 4 | 3 | 4 | 4 | 42 | 8 | — |
| barite | AHR | 130 | 70 | 50 | 28 | 5 | 3 | 5 | 6 | 60 | 10 | 1.5 |
| (FGB) | | | | | | | | | | | | |
| MT/FGB: | BHR | 78 | 44 | 32 | 18 | 4 | 3 | 4 | 6 | 34 | 10 | — |
| 50/50 | AHR | 110 | 65 | 49 | 32 | 8 | 7 | 8 | 10 | 45 | 20 | 1.9 |

High Temperature/High Pressure

The high-temperature/high-pressure fluid loss of the manganese tetroxide-based fluid (Table 5) was measured at 180° C. and 500-psi differential pressure over a 30-minute period. The tests were carried out under static and dynamic conditions. In static filtration, the filtercake was allowed to build in a quiescent fluid, whereas in dynamic filtration the cake was formed while the fluid was stirred at a certain speed by a paddle stirrer.

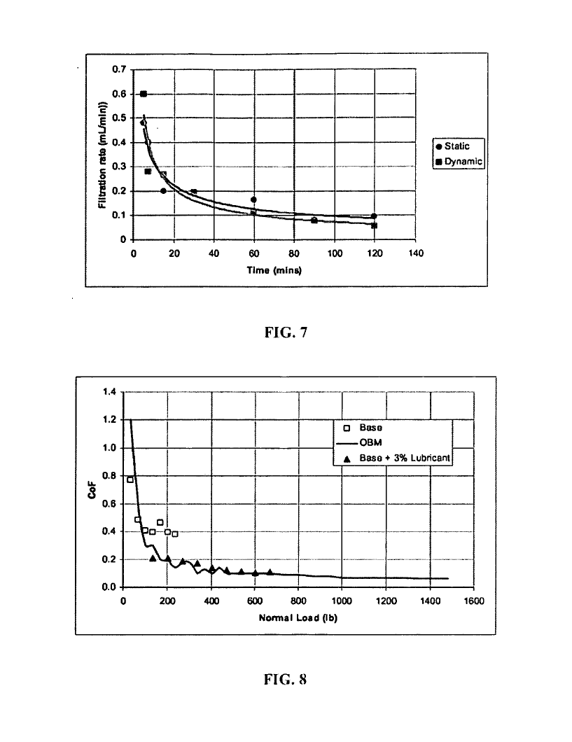

The static HTHP fluid loss was measured using ceramic discs with 10-im pore throat size. The 30-minute fluid loss was 13.7 mL, which is an acceptable level for a water-based drilling fluid at such high temperature. A plot of the filtration rate versus time, FIG. 7, shows that filtration rate drops significantly after about one hour.

The dynamic fluid loss was also measured on 10-im ceramic discs. A plot of the filtration rate as a function of time is shown in FIG. 7. Comparison of the results shows that there is not a significant difference between the dynamic and static fluid loss of this fluid. Both tests produced filter cakes that were about 4 mm thick.

Shale Inhibition

The inhibitive properties of the fluid were investigated by performing cuttings dispersion tests on Oxford and London clays. Clay particles sized to 2-4 mm were placed in the fluid and hot rolled for 16 hours at 180° C. The difference in the dry weight of the cuttings before and after the test gave the percentage recovery of the synthetic cuttings. As illustrated in Table 9, close to 100% recovery could be obtained by adding around 5 lb/bbl potassium chloride to the fluid. The concentration of the organic stabilisers may also need to be increased in order to maintain the rheology and fluid loss properties of the fluid.

TABLE 9
Results of Cuttings Recovery Tests on London and Oxford
Clay (after hot rolling for 16 hours at 180° C.)

| | | | | API | Recovery |
|---|---|---|---|---|---|
| Fluid | Clay | PV | YP | (ml) | (% w/w) |
| Base | London | 42 | 23 | 4.7 | 86 |
| | Oxford | 38 | 29 | 17.0 | 65.2 |
| Base + 5 lb/bbl | London | 47 | 48 | 2.4 | 100 |
| KCl | Oxford | 22 | 93 | 9.0 | 100 |

Contamination Tests

Sensitivity to contaminants was evaluated by determining the impact of seawater, cement and drill solids contamination on key fluid properties. The contaminants tested were 10% seawater, 5% Class G cement and 10% clay. Table 10 gives the results of such tests on the fluid. The results showed that seawater contamination does not have an adverse effect on fluid properties. Cement contamination lowers YP but increases PV and fluid loss, albeit not to a drastic extent. Clay contamination causes significant increases in PV, YP and fluid loss. However, further tests showed that the impact of both cement and clay contamination can be lessened by treatment of the fluid with further doses of the organic dispersants.

TABLE 10
Contamination Test Results

| | | | Fann 35 readings at | | | | | | Gels | | | API |
|---|---|---|---|---|---|---|---|---|---|---|---|---|
| Fluid | | 600 | 300 | 200 | 100 | 6 | 3 | 10 s | 10 m | PV | YP | (mL) |
| Base | BHR | 57 | 31 | 23 | 14 | 4 | 3 | 4 | 5 | 26 | 5 | — |
| | AHR | 65 | 39 | 29 | 19 | 6 | 5 | 7 | 12 | 26 | 13 | 2.6 |
| Base + 10% | BHR | 38 | 24 | 19 | 13 | 5 | 4 | 6 | 9 | 14 | 10 | — |
| seawater | AHR | 68 | 41 | 31 | 20 | 7 | 5 | 8 | 17 | 27 | 14 | 3.0 |
| Base + 5% | BHR | 86 | 48 | 35 | 21 | 5 | 4 | 3 | 2 | 38 | 10 | — |
| cement | AHR | 87 | 47 | 33 | 18 | 3 | 2 | 3 | 2 | 40 | 7 | 6.8 |
| Base + 10% | BHR | 58 | 36 | 25 | 16 | 4 | 3 | 5 | 6 | 22 | 14 | — |
| clay | AHR | 119 | 78 | 62 | 42 | 15 | 11 | 16 | 23 | 41 | 37 | 22.0 |

Lubricity

Lubricity measurements were made on a Falex lubricity tester, which utilizes metal-on-metal contact. In this equipment, a stainless steel rod, immersed in the test fluid and held in place by a brass pin, is embraced by two stainless steel v-blocks. A rotating mechanism turns the rod at a fixed speed and applies a load to the two v-blocks, which presses them against the rotating rod. The pressure exerted by the v-blocks generates a torque in the rod that is measured by a torque mechanism. The coefficient of friction is measured from the slope of the torque versus load plot.

Initial tests showed that the fluid would benefit from addition of a lubricant. A number of liquid and solid lubricants were evaluated in the formulation of Table 5. Lubricity measurements were made at ambient temperature after the fluid containing the lubricant had been hot rolled for 16 hours at 180° C. Of the lubricating additives that survived the hot roll temperature, an additive consisting of a mixture of propylene glycol derivatives gave the best performance. At a concentration of 3%, it reduced the friction coefficient from 0.44 (for the untreated fluid) to 0.11. FIG. 8 compares the lubricity test results of the fluid with that of the base and a conventional oil-based fluid. The additive produced no adverse effect on key fluid properties such as rheology and fluid loss.

While the claimed subject matter has been described with respect to a limited number of embodiments, those skilled in the art, having benefit of this disclosure, will appreciate that other embodiments can be devised which do not depart from the scope of the claimed subject matter as disclosed herein. Accordingly, the scope of the claimed subject matter should be limited only by the attached claims.

What is claimed:

1. An aqueous based wellbore fluid comprising:
at least one ionized polymer;
at least one non-ionic polymer;
a non-magnetic weighting agent; and
an aqueous base fluid.

2. The wellbore fluid of claim 1, wherein the at least one ionized polymer has a charge selected from the group consisting of anionic, cationic, and combinations thereof.

3. The wellbore fluid of claim 1, wherein the at least one ionized polymer comprises modified acrylic polymers.

4. The wellbore fluid of claim 3, wherein the modified acrylic polymer comprises a vinyl sulfonated copolymer.

5. The wellbore fluid of claim 1, wherein the at least one nonionic polymer has a moderate molecular weight.

6. The wellbore fluid of claim 1, wherein the at least one non-ionic polymer comprises polyvinylpyrrolidone.

7. The wellbore fluid of claim 5, wherein polyvinylpyrrolidone has a K value of at least 50.

8. The wellbore fluid of claim 6, wherein polyvinylpyrrolidone has a K value of at least 90.

9. The wellbore fluid of claim 1, wherein the wellbore fluid provides fluid loss control at temperatures of at least 130° C.

10. The wellbore fluid of claim 1, wherein the non-magnetic weighting agent has a surface charge.

11. The wellbore fluid of claim 10, wherein the non-magnetic weighting agent comprises manganese tetroxide.

12. A method for drilling a wellbore comprising:
circulating an aqueous based wellbore fluid while drilling, wherein the aqueous based wellbore fluid comprises at least one ionized polymer, at least one non-ionic polymer, a non-magnetic weighting agent, and an aqueous base fluid.

13. The wellbore fluid of claim 12, wherein the at least one ionized polymer has a charge selected from the group consisting of anionic, cationic, and combinations thereof.

14. The wellbore fluid of claim 12, wherein the at least one ionized polymer comprises modified acrylic polymers.

15. The wellbore fluid of claim 14, wherein the modified acrylic polymer comprises a vinyl sulfonated copolymer.

16. The wellbore fluid of claim 12, wherein the at least one nonionic polymer has a moderate molecular weight.

17. The wellbore fluid of claim 12, wherein the at least one nonionic polymer comprises polyvinylpyrrolidone.

18. The wellbore fluid of claim 16, wherein polyvinylpyrrolidone has a K value of at least 50.

19. The wellbore fluid of claim 17, wherein polyvinylpyrrolidone has a K value of at least 90.

20. The wellbore fluid of claim 12, wherein the wellbore fluid provides fluid loss control at temperatures of at least 130° C.

21. The wellbore fluid of claim 12, wherein the at least one non-magnetic weighting agent has a surface charge.

22. The wellbore fluid of claim 21, wherein the at least one non-magnetic weighting agent comprises manganese tetroxide.
